(19) United States
(12) Patent Application Publication
(10) Pub. No.: US 2013/0094198 A1
(43) Pub. Date: Apr. 18, 2013

(54) LAMP WITH DIFFUSER SHEETS FOR HIGHLY ILLUMINATIVE EFFICIENCY

(71) Applicant: Wen-Sung LEE, TAICHUNG CITY (TW)

(72) Inventor: Wen-Sung LEE, TAICHUNG CITY (TW)

(21) Appl. No.: 13/272,228

(22) Filed: Oct. 13, 2011

(51) Int. Cl. F21V 13/04

(52) U.S. Cl. 362/217.05

(57) ABSTRACT

A lamp with diffuser sheets for highly illuminative efficiency includes a base having a central rod, at least one light bar attached on the central rod and electrically communicating to a light processing unit, a plurality of LED illuminants being equidistantly set up on the light bar, a cover being composed of diffuser sheets with uniform thickness, the cover being flexible, the diffuser sheet being made from polycarbonates which have high reflection coefficient for directing as much light as possible, the cover enclosing the base, the light processing unit being set in a base, the light processing unit being used to light up at different modes. In this way, only fewer LED illuminants can perform as a LED ring tube or a plurality of LED sources with a circular arrangement to illuminate the environment with the same illumination, but it costs less energy because fewer light sources are used.

### BACKGROUND OF THE INVENTION

1. Field of the Invention

The present invention relates to a lamp, more particularly to a lamp with diffuser sheets for highly illuminative efficiency.

2. Description of Related Art

With the development of high efficiency and high power LEDs, it has become possible to use LEDs in lighting and illumination. Replacement light bulbs have been made, as well as dedicated fixtures and LED lamps. LEDs are used as street lights and in other architectural lighting where color changing is used.

A conventional LED lamp often places LED illuminants with a cover surrounding on the walls or on the pillars for illumination. The LED illuminant has focusing light beams. This is why the flashlights, desk lights and spotlights often use the LED illuminant as the light source today. However, the illuminative range of the LED illuminant is narrow than the traditional light bulbs. Thus, if the LED lamp is used to illuminate a large area, the LED lamp usually has many LED illuminants inside. Although many LED illuminants in the LED lamp can illuminate the large area, it costs too much electricity power. One LED illuminant is lower energy consumption, but many LED illuminants consume much energy which is not eco-friendly.

Recently, Bayer MaterialScience AG provides one diffuser sheet which is made from polycarbonates. The polycarbonates with high reflection coefficient can be used to direct as much light as possible. The diffuser sheet is widely using in the LED displayer for achieving a uniform light distribution while maintaining high light transmission, but it is uncommon to use in the LED lamp. If the lamp cover can be made from the polycarbonates or the diffuser sheets are coating on the surface of the lamp cover, the disadvantage of the conventional LED lamp can be overcome. In other words, the LED lamp can illuminate the large area by using fewer LED illuminants and consume less electricity power to save energy.

The present invention has arisen to mitigate and/or obviate the disadvantages of the conventional.

### SUMMARY OF THE INVENTION

The main objective of the present invention is to provide an improved lamp with diffuser sheets for highly illuminative efficiency.

To achieve the objective, a lamp with diffuser sheets for highly illuminative efficiency comprises a base having a central rod, at least one light bar attached on the central rod and electrically conducting to a light processing unit, a plurality of LED illuminants being equidistantly set up on the light bar, a cover being composed of diffuser sheets with uniform thickness, the cover being flexible, the diffuser sheet being made from polycarbonates which have high reflection coefficient for directing as much light as possible, the cover enclosing the base, the light processing unit being set in a base, the light processing unit being used to control the LED illuminants to light up at different modes, a switch being set on the base and electrically communicated to the light processing unit for a user to switch.

Each of the LED illuminants can emit light beams with single color or different colors.

Further benefits and advantages of the present invention will become apparent after a careful reading of the detailed description with appropriate reference to the accompanying drawings.

### BRIEF DESCRIPTION OF THE DRAWINGS

FIG. 1 is an exploded view of a lamp with diffuser sheets for highly illuminative efficiency in accordance with the present invention;

FIG. 2 is a perspective view of the lamp with diffuser sheets for highly illuminative efficiency for showing a light trajectory as a ring shape;

FIG. 3 is a perspective view of the second embodiment for showing a light trajectory as a vertical bar;

FIG. 4 is a perspective view of the third embodiment as an alarm device; and

FIG. 5 is a perspective view of the fourth embodiment as a traffic indicating device.

### DETAILED DESCRIPTION OF THE INVENTION

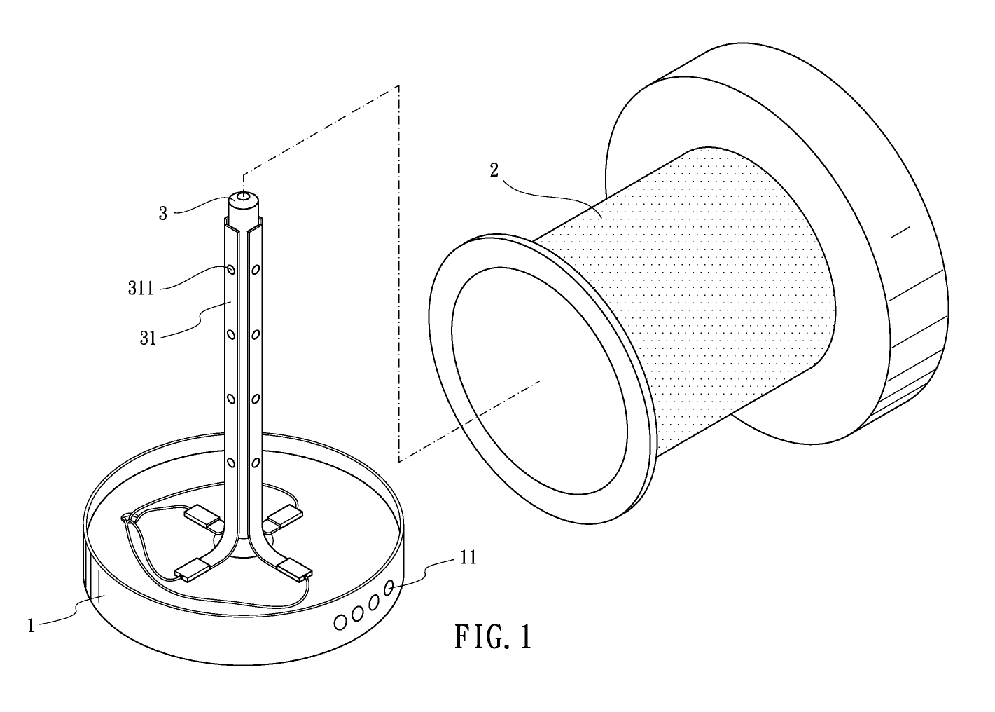

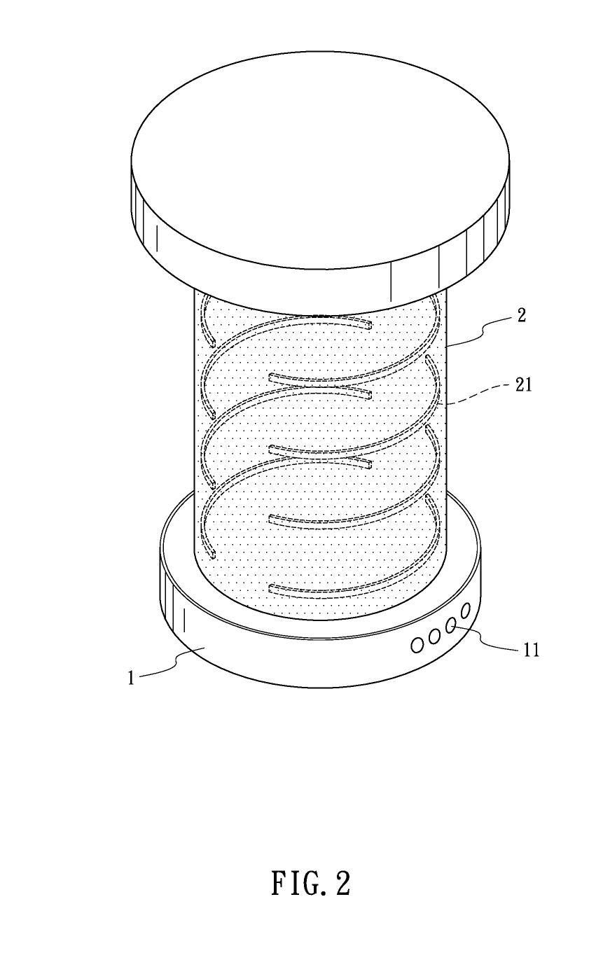

Referring to FIGS. 1-2, a lamp with diffuser sheets for highly illuminative efficiency in accordance with the present invention comprises a base 1, a central rod 3, a plurality of LED illuminants 311, a cover 2, a light processing unit (not shown) being set in the base 1, and a switch 11.

The base 1 has the central rod 3. At least one light bar 31 is attached on the central rod 3 and electrically communicating to the light processing unit. The LED illuminants 311 are equidistantly set up on the light bar 31. In the present embodiment, there are four light bars 31 and each light bar 31 has four LED illuminants 311 aligned vertically. Each of the LED illuminants 311 with a small volume can emit light beams with single color or different colors.

The light processing unit is set in the base 1 and electrically communicating to the switch 11. The light processing unit is used to control the LED illuminants 311 to light up at different modes, such as flash light mode, normal light mode, white light mode and sleep light mode. A user can press the switch 11 to control the light processing unit for performing his/her desired mode.

A cover 2 is composed of diffuser sheets with uniform thickness and the cover 2 is flexible. The diffuser sheet is made from polycarbonates which have high reflection coefficient for directing as much light as possible. The cover 2 encloses the base 1 and the LED illuminants 311 on the light bar 31 emit the light to the cover 2. When the light comes to the cover 2, the light is multi-reflected and multi-refracted at the diffuser sheet so that the diffuser sheet directs the light to travel in one particular light trajectory 21. As shown in FIG. 2, the light trajectories 21 are horizontal ring shapes to illuminate the environment. In this embodiment, each of light trajectories 21 with ring shape is formed by only four LED illuminants 311 instead of a ring LED tube or a plurality of LED sources with a circular arrangement. Thus, the illuminative efficiency of the LED source is improved dramatically.

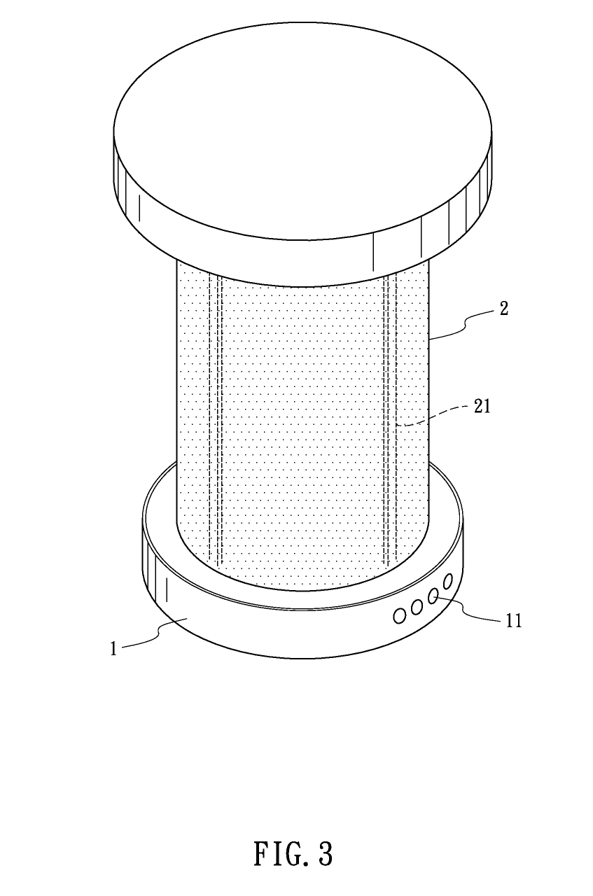

Referring to the second embodiment as shown in FIG. 3, when the diffuser sheets are rotated 90 degrees, the light emitted from the LED illuminants 311 are traveling in the four vertical light trajectories 21 corresponding to the four light bars 31. The performance of the LED illuminants 311 is changed easily by the orientation of the diffuser sheets.

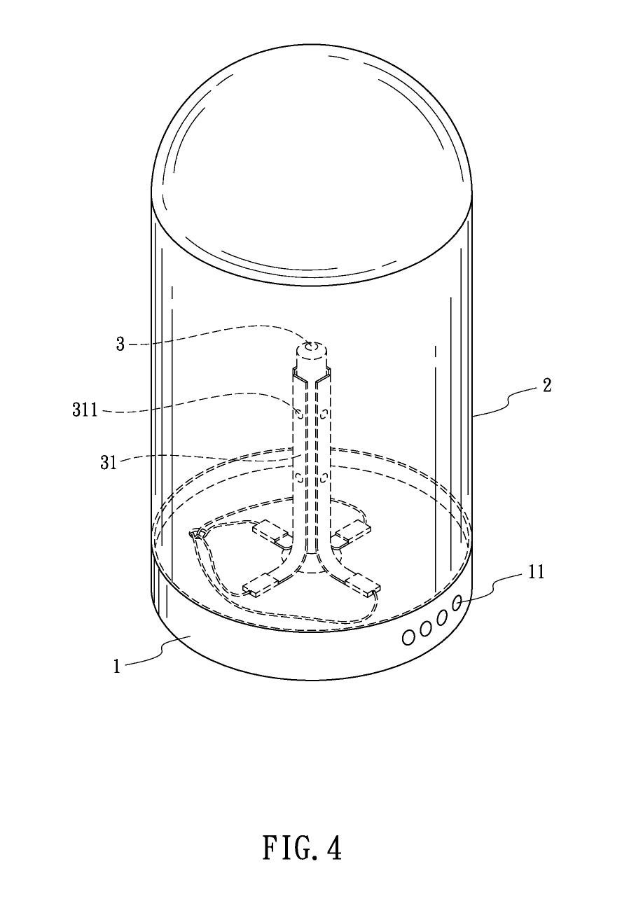

Referring to FIG. 4, the third embodiment is an alarm device.

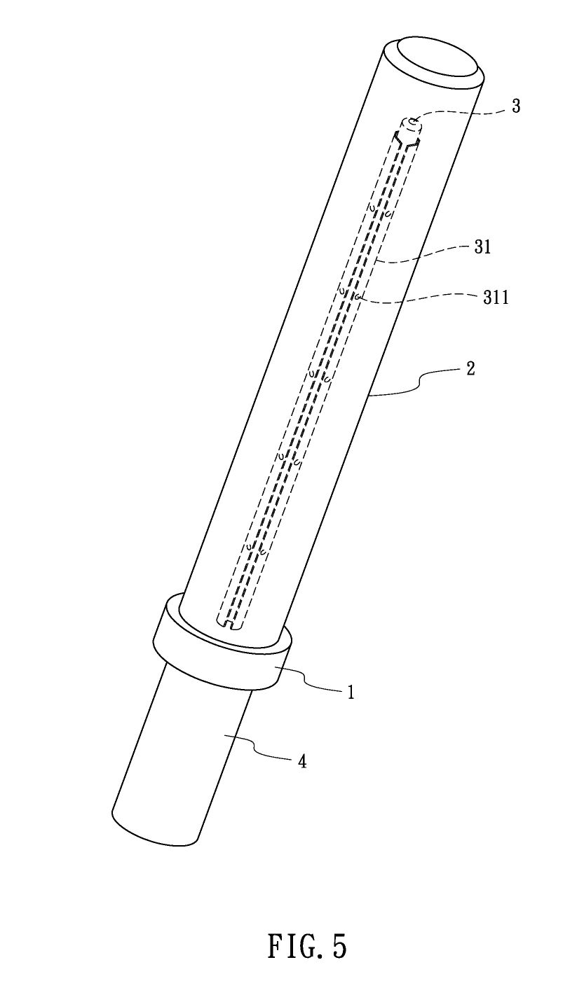

Referring to FIG. 5, the fourth embodiment is a traffic indicating device.

The advantage of the present invention should be emphasized here again. When the cover 2 is composed of diffuser sheets with uniform thickness, the diffuser sheets can direct the light from the LED illuminants 311 and transform the point light into a particular light trajectory 21, such as a ring shape or a vertical bar shape. In this way, only fewer LED illuminants 311 can perform as a LED ring tube or a plurality of LED sources with a circular arrangement to illuminate the environment with the same illumination, but it costs less energy because fewer light sources are used.

Although the invention has been explained in relation to its preferred embodiment, it is to be understood that many other possible modifications and variations can be made without departing from the spirit and scope of the invention as hereinafter claimed.

What is claimed is:

1. A lamp with diffuser sheets for highly illuminative efficiency comprising:
a base having a central rod, at least one light bar attached on the central rod and electrically conducting to a light processing unit, a plurality of LED illuminants being equidistantly set up on the light bar;
a cover being composed of diffuser sheets with uniform thickness, the cover being flexible, the diffuser sheet being made from polycarbonates which have high reflection coefficient for directing as much light as possible, the cover enclosing the base;
the light processing unit being set in a base, the light processing unit being used to control the LED illuminants to light up at different modes; and
a switch being set on the base and electrically communicated to the light processing unit for a user to switch.

2. The lamp with diffuser sheets for highly illuminative efficiency as claimed in claim 1, wherein each of the LED illuminants can emit light beams with single color or different colors.
